(19) United States
(12) Patent Application Publication
(10) Pub. No.: US 2005/0150442 A1
(43) Pub. Date: Jul. 14, 2005

(54) Seed meter

(76) Inventor: Enrique Friesen, Liberal, KS (US)

Correspondence Address: HOVEY WILLIAMS LLP, Suite 400, 2405 Grand, Kansas City, MO, 64108, US

(21) Appl. No.: 10/757,181

(22) Filed: Jan. 14, 2004

(51) Int. Cl. A01C 7/00; A01C 9/00

(52) U.S. Cl. 111/185

(57) ABSTRACT

A vacuum seed meter for metering individual seeds at consistent intervals. The seed meter employs an improved seed disk defining a plurality of seed attachment holes for holding seeds on the disk via a vacuum attachment force. Each seed attachment hole is configured to allow a seed to be held against one side of the disk without permitting the seed to extend entirely through the attachment hole and protrude from the opposite side of the disk. In addition, the seed disk is configured to provide enhanced resistance to bending. No gaskets or brushes that maintain contact with the seed disk are required. The seed meter also employs an improved second-seed eliminator disposed alongside the seed disk. The second-seed eliminator presents a substantially smooth leading edge that is configured to contact a second seed held by an attachment hole, thereby decoupling the second seed from the disk. The second-seed eliminator can be shifted via contact with a seed firmly attached to the seed disk, thereby preventing shearing of the seed by the seed eliminator.

### BACKGROUND OF THE INVENTION

1. Field of the Invention

The present invention relates generally to agricultural seed planting devices. In another aspect, the invention concerns an improved seed meter for metering individual seeds at consistent intervals.

2. Discussion of Prior Art

A variety of configurations of agricultural planters are available on the market today. One popular type of planter is known as a vacuum or air planter. A typical vacuum planter can be used to simultaneously plant 8 to 16 (typically 12) rows of seed. Vacuum planters include one negative air-pressure (i.e., vacuum) seed meter for each row planted. These vacuum seed meters are configured to discharge individual seeds at consistent intervals.

Conventional vacuum seed meters include a housing attached to a vacuum source and a seed disk disposed in and rotatable relative to the housing. The seed disk defines a plurality of symmetric seed attachment holes where individual seeds are coupled to the rotating seed disk via a vacuum attachment force. The seed disk carries the seeds from a seed bin defined within the housing to a disengagement zone. When the seed enters the disengagement zone, the vacuum attachment force is reduced or eliminated so that the seed is released from the seed disk. Once the seed is released from the seed disk, the seed is permitted to fall through a seed tube and into a furrow in the ground created by an opener of the vacuum planter. Many conventional vacuum seed meters include a second-seed eliminator configured to knock off a second seed coupled to the seed disk at a single seed attachment hole. Also, conventional vacuum seed meters typically include one or more gaskets and/or brushes that maintain contact with the seed disk and are operable to separate the seed bin from the disengagement zone or to separate zones of different pressure (i.e., vacuum zones and ambient zones).

Conventional vacuum seed meters, however, present numerous disadvantages and problems. For example, many conventional seed meters have a problem with premature wear and failure of the seed disk, gaskets, and/or brushes caused by kinetic friction between the parts. Where the gasket prematurely wears, the seeds are able to leak into the disengagement zone directly from the seed bin and short-circuit the meter to result in double-planting of seed. Another problem associated with conventional seed meters is the propensity of rigid seed eliminators to shear or otherwise damage the seeds contacted therewith. Still another problem associated with conventional seed meters is their use of flexible seed disks. These seed disks can easily be bent when an attached seed contacts the rigid seed eliminator. Bending of the seed disk has two main disadvantages. First, a bent seed disk tends to contact other non-rotating components of the seed meter, thereby causing wear on the disk and/or the contacted non-rotating component. Second, a bent seed disk will typically “snap” back into place when the force causing bending is eliminated. This rapid “snapping” back into its original shape can cause a number of the seeds to become detached from the seed disk, thereby resulting in a gap in seed planting.

Finally, another problem associated with many conventional seed meters is that the seed disk is too thin and allows seeds to extend entirely through the seed attachment openings and protrude from the opposite side of the seed disk. These protruding seeds can contact structures on the opposite side of the seed disk, thereby causing damage to the seed, damage to the structure, and/or acceleration of the seed out of the attachment hole and away from the seed disk. When the contact between a protruding seed and a structure on the opposite side of the seed disk causes acceleration of the seed away from the seed disk, this acceleration of the seed can result in the seed “rattling” back and forth down the seed tube. When the seed rattles back and forth down the seed tube, it takes longer for the rattling seed to reach the bottom of the seed tube and allows a subsequent, properly-disengaged seed to catch up with the rattling seed, thereby resulting in the undesirable planting of the two seeds in close proximity to one another.

### SUMMARY OF THE INVENTION

Responsive to these and other problems of by conventional seed meters, the present invention concerns an improved seed meter for metering individual seeds at consistent intervals. Among other things, the present invention is useful for eliminating double-planting of seeds, minimizing gaps in seed planting, minimizing damage to planted seeds, and for reducing internal friction and the associated wearing of internal component parts. A further advantage of the present invention is the ability of the inventive seed meter to accurately meter seeds of variable sizes.

A first aspect of the present invention concerns a seed meter that includes a housing at least partly defining a seed bin and a disengagement zone. The meter also includes a seed disk operable to carry seeds from the seed bin to the disengagement zone when rotated relative to the housing on a disk axis of rotation. The meter includes a seed eliminator at least partly disposed alongside the seed disk and operable to contact at least one of the seeds carried by the seed disk. The seed eliminator is shiftable from a normal position to a deflected position via contact with the seeds.

A second aspect of the present invention concerns a seed meter that includes a housing at least partly defining an internal chamber and a seed disk at least partly disposed in the housing and rotatable relative thereto. The seed disk presents a seed side and a vacuum side, so as to divide the chamber into a seed portion and a vacuum portion. The seed and vacuum portions of the chamber are located adjacent the seed and vacuum sides of the seed disk, respectively. The seed disk defines a plurality of seed attachment holes extending axially through the disk from the seed side of the disk to the vacuum side of the disk. Each of the seed holes has a minimum diameter that is axially spaced from the vacuum side at least one eighth of an inch.

A third aspect of the present invention concerns a seed meter including a housing at least partly defining a seed bin and disengagement zone and a seed disk disposed within and rotatable relative to the housing. The disk defines a plurality of seed attachment holes configured to carry seeds from the seed bin to the disengagement zone when the disk is rotated. The disk has a resistance to bending such that a normal force greater than five pounds is required to cause a deflection of one eighth of an inch when the disk is fixed at the geometric center of the disk and the force and deflection are applied and measured at a location five inches from the geometric center of the disk.

A fourth aspect of the present invention concerns a seed meter comprising a housing and a seed disk. The housing at least partly defines an internal chamber. The seed disk is at least partly disposed in the internal chamber and divides the internal chamber into a seed-transfer portion and a pressure-controlled portion. The housing includes a substantially rigid separator wall dividing the pressure-controlled portion into a vacuum zone and an ambient zone. The separator wall is spaced from the seed disk and presents a substantially rigid terminal edge extending alongside the seed disk. The terminal edge is spaced from the seed disk by a maximum distance of not more than about one sixteenth of an inch.

A fifth aspect of the present invention concerns a rotatable seed disk adapted for use in a vacuum seed meter. The disk presents a substantially flat and substantially circular panel. The panel presents first and second generally parallel and opposite faces. The panel defines a central axis of rotation and a plurality of seed attachment holes equally spaced from the axis of rotation and from one another. Each of the holes presents a minimum diameter, at least a portion of which is spaced from one of the first and second surfaces by at least three-sixteenths of an inch.

A sixth aspect of the present invention concerns a method of metering seeds. The method comprises the steps of: (a) introducing the seeds into a seed meter comprising a housing and a seed disk disposed in the housing, with the housing and the seed disk cooperatively defining a seed bin for holding the seeds; (b) coupling a plurality of the seeds to the seed disk; (c) rotating the seed disk relative to the housing to thereby transport the seeds coupled to the disk from the seed bin to a disengagement zone; and (d) decoupling the seeds from the seed disk in the disk engagement zone. The rotating of step (c) is performed without contacting the seed disk with any non-rotating solid items other than the seeds in the seed bin.

Other aspects and advantages of the present invention will be apparent from the following detailed description of a preferred embodiment and the accompanying drawing figures.

### BRIEF DESCRIPTION OF THE DRAWING FIGURES

A preferred embodiment of the invention is described in detail below with reference to the attached drawing figures, wherein:

FIG. 1 is a side elevational view of the rear frame of a vacuum planter, particularly illustrating an attached seed meter constructed in accordance with the present invention;

FIG. 2 is a rear elevational view of the seed meter shown in FIG. 1 and the seed hopper;

FIG. 3 is a side elevational view of the seed meter and a fragmentary elevational view of the vacuum attachment tube, particularly showing in solid line the vacuum attachment latch in an open position, and in phantom line the vacuum attachment latch in a locked position;

FIG. 4 is an exploded elevational view of the seed meter in an opened condition with the seed disk being removed;

FIG. 5 is an exploded perspective view of the seed meter, particularly illustrating the pressure-control surface of the disk;

FIG. 6 is an exploded perspective view of the seed meter, particularly illustrating the seed-transfer surface of the disk;

FIG. 7 is a cross-sectional view of the seed meter taken along line 7-7 in FIG. 2;

FIG. 8 is a cross-sectional view of the seed meter taken along line 8-8 in FIG. 3;

FIG. 9 is an enlarged fragmentary view of the seed meter as shown in FIG. 8, particularly illustrating the spacing between the seed disk and housing;

FIG. 10 is a cross-sectional view of the seed disk taken along line 10-10 in FIG. 7, particularly illustrating a groove in the seed disk;

FIG. 11A is a fragmentary elevational view of the seed meter, particularly illustrating the seed eliminator in a normal condition and a seed attachment hole carrying an excess seed;

FIG. 11B is a fragmentary elevational view of the seed meter shown in FIG. 11A, particularly illustrating in solid line the seed eliminator in a deflected position, and in hidden line the seed eliminator in the normal position;

FIG. 11C is a fragmentary elevation view of the seed meter shown in FIGS. 11A and B, particularly illustrating in solid line the seed eliminator in the normal position, in phantom line the seed eliminator in a shifted position, and the excess seed dislodged; and

FIG. 12 is a side elevational view of the seed disk, particularly illustrating in solid line the disk in an unflexed position and in phantom line the disk in a flexed position.

### DETAILED DESCRIPTION OF THE PREFERRED EMBODIMENT

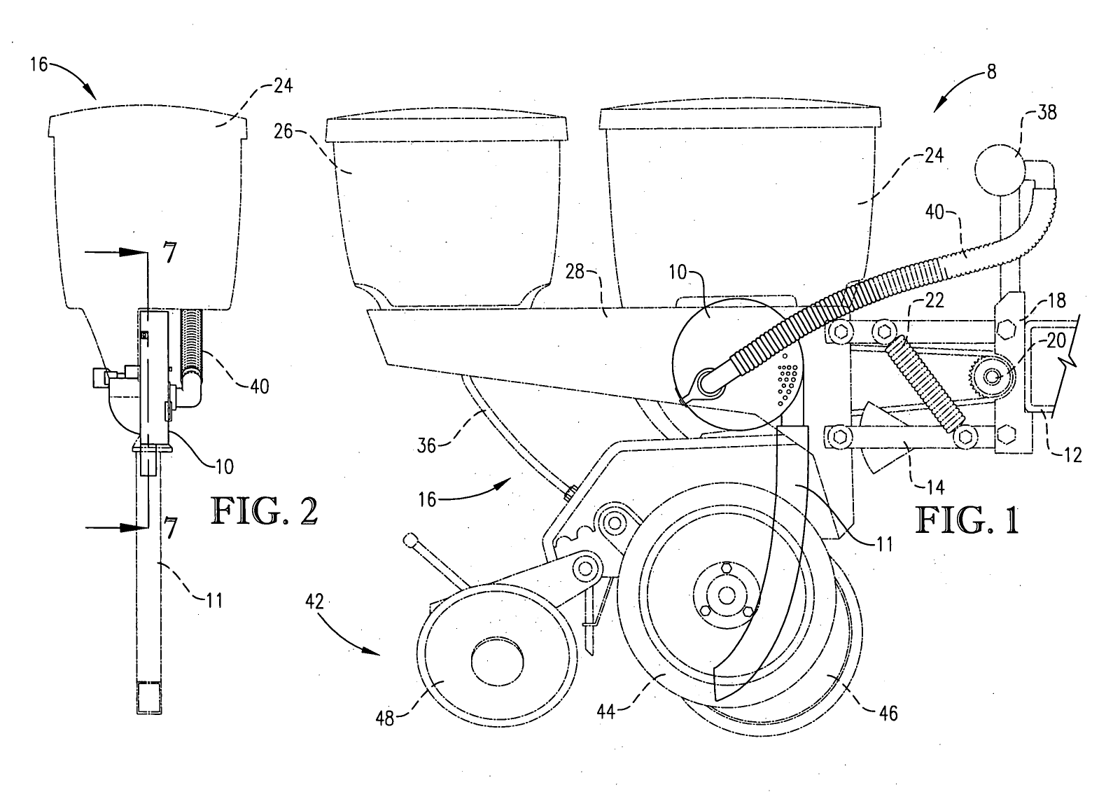

Referring initially to FIGS. 1 and 2, the present invention concerns a vacuum planter 8 equipped with an improved vacuum seed meter 10 for continuously planting single agricultural seeds (e.g., cotton, soybeans, and corn) at a predetermined rate. The improved seed meter 10 is attached to a rear frame 14 of a mobile support structure 12 of the planter 8. The frame 14 is provided for supporting and manipulating a plurality of planting assemblies 16 and includes a mount 18 for connecting the frame 14 to the mobile support structure 12. The frame 14 includes a linear actuator 22 for vertically shifting the frame 14 relative the mobile carrier 12 between a lower engaged position and a raised transportation position. A drive mechanism 20 can also be coupled to the frame 14. The drive mechanism 20 can be configured to transfer the rotation of the wheels (not shown) of the planter 8 to the seed meter 10. Alternatively, the drive mechanism 20 can be electrically or hydraulically driven. Typically, the planter 8 includes, and the frame 14 is configured to support, an average of twelve planting assemblies 16. However, each planting assembly 16 is virtually identical and as such only one assembly 16 is illustrated (e.g., FIG. 2) and further described herein with the understanding that the other seed planting assemblies 16 are similarly constructed.

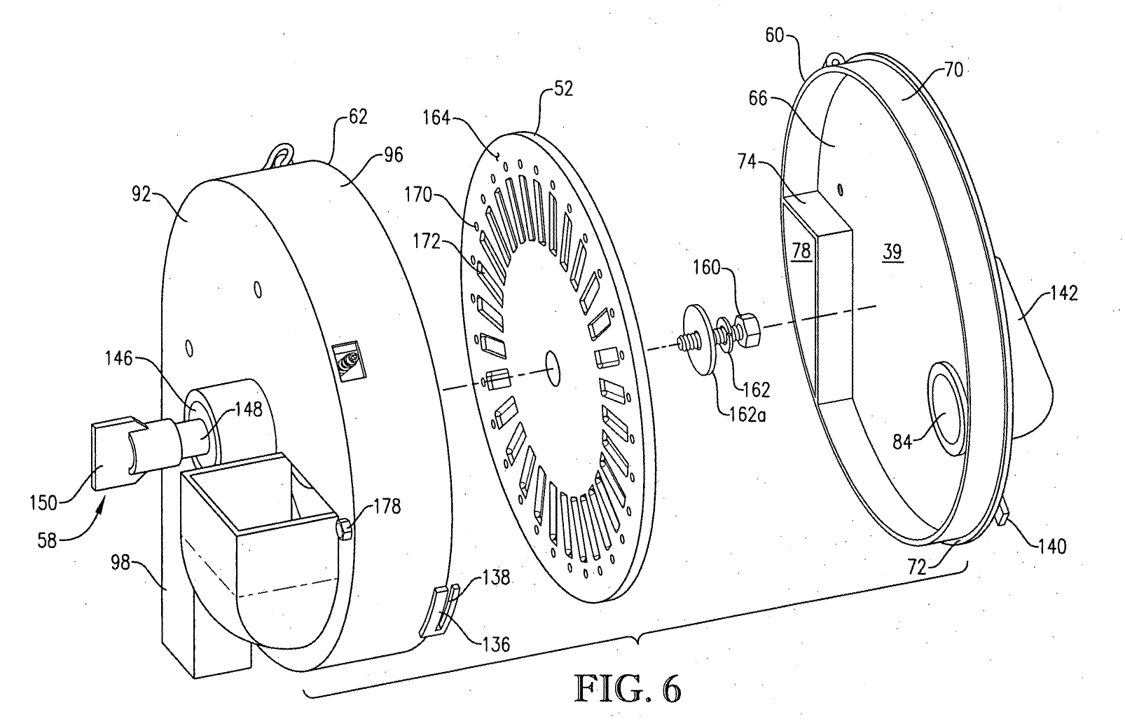

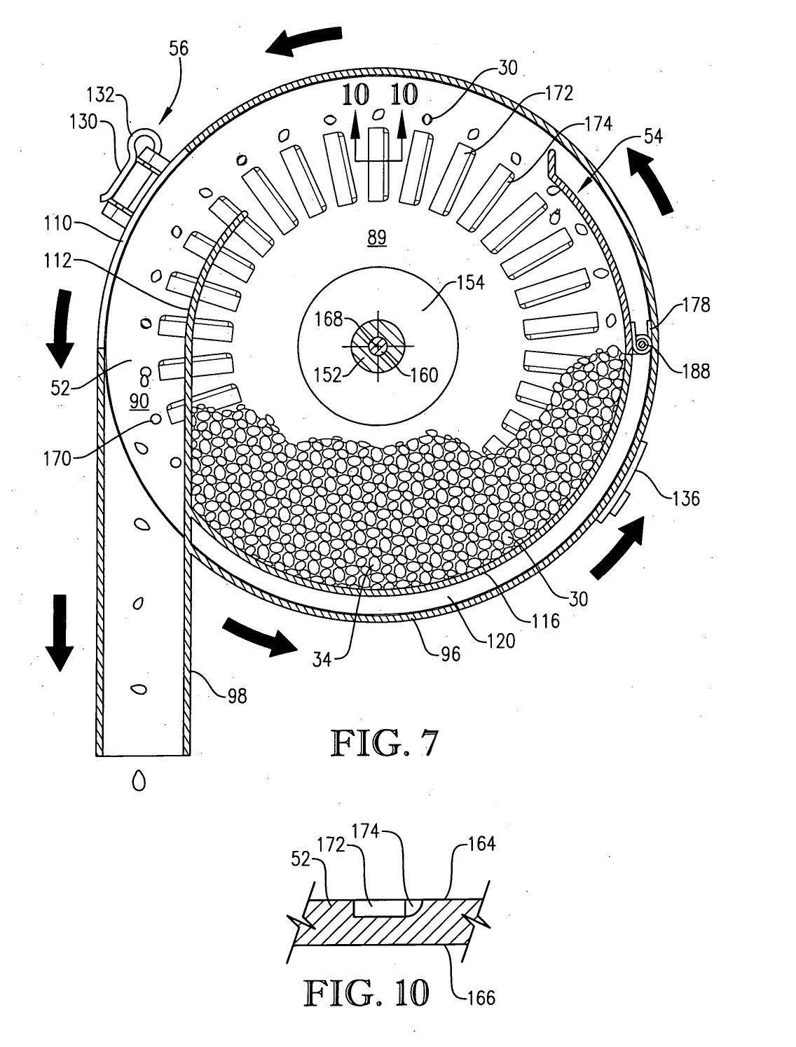

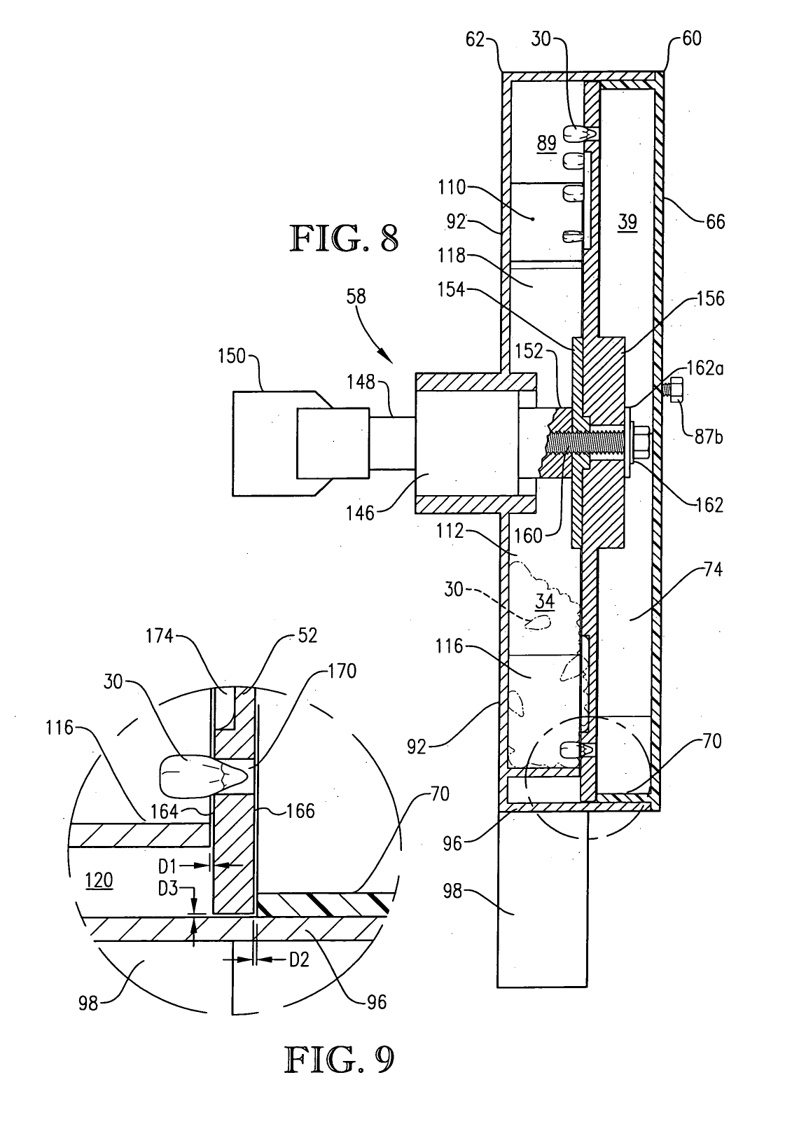

Each planting assembly 16 includes a seed hopper 24 and a fertilizer and/or pesticide hopper 26, wherein reservoirs of seed and fertilizer and/or pesticide are stored, respectively. A support structure 28 supports the planting assemblies 16 on the frame 14. At least one valve (not shown) is typically provided for delivering a plurality of seeds 30 (FIGS. 7 and 8) from the hopper 24 into a seed bin 34 (FIGS. 7 and 8) defined within the seed meter 10. Referring again to FIGS. 1 and 2, a fertilizer-delivery means, including a fertilizer tube 36, is typically provided for delivering fertilizer to the soil. A vacuum source 38 (e.g., a hydraulically driven pump) is typically supported by the frame 14 and connected to the seed meter 10 via a flexible vacuum tube 40. The vacuum source 38 provides negative air-pressure within a vacuum zone 39 (FIGS. 6 and 8) of the seed meter 10 as described in more detail herein, and more preferably, provides a variable vacuum depending upon the size of the seed to be planted. Typically, either a wheel or a hydraulic motor (not shown) is drivingly connected to the meter 10 via drive mechanism 20 to provide rotational energy to the drive subassembly 58 (FIGS. 6 and 8) of the meter 10. The frame 14 and support structure 28 support a soil tilling subassembly 42, which is generally positioned beneath the seed meter 10. The tilling subassembly 42 includes a preparatory soil opening wheel 44 that is supported by and rollingly engages the ground. The wheel 44 presents two staggered circular blades 46 that are configured to cut a V-notch furrow of sufficient depth into the soil. The opening wheel 44 is typically bisected along its vertical midline, so as to enable a seed ejector tube 11 connected to the seed meter 10 to extend therebetween. Thus, the wheel 44 also serves as an ejector tube guard. Finally, after a seed is placed in the furrow, a pair of staggered closing wheels 48 are positioned to close the furrow and compact the soil around the seed. While the improved seed meter 10 is described herein in conjunction with the frame 14 and as part of planting assembly 16, it is certainly within the ambit of the present invention to utilize the seed meter 10 with other planting assemblies, frame configurations, or combinations thereof.

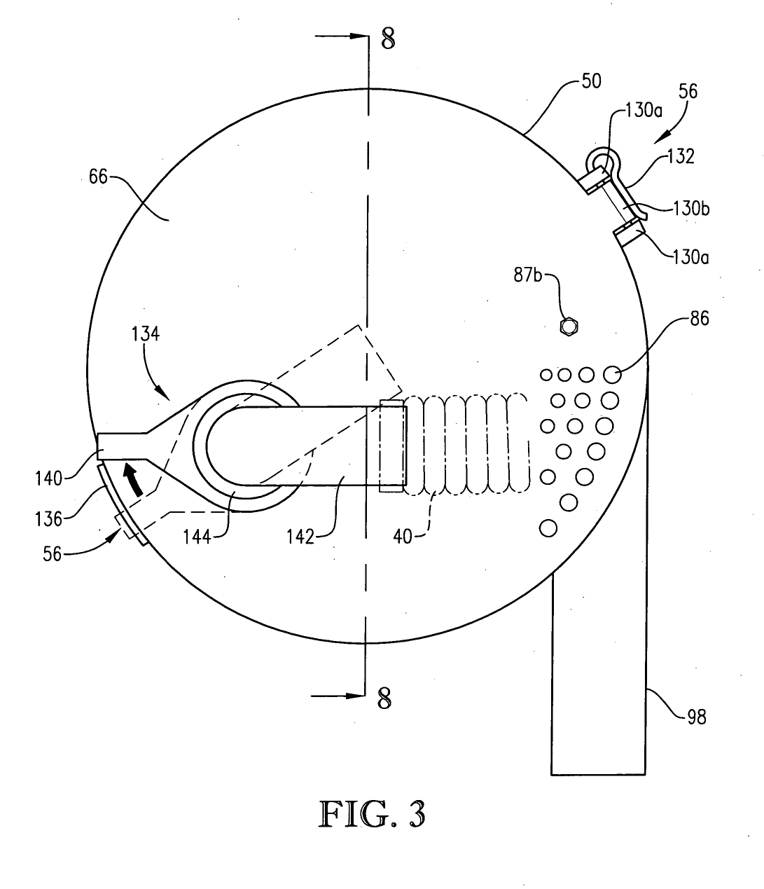

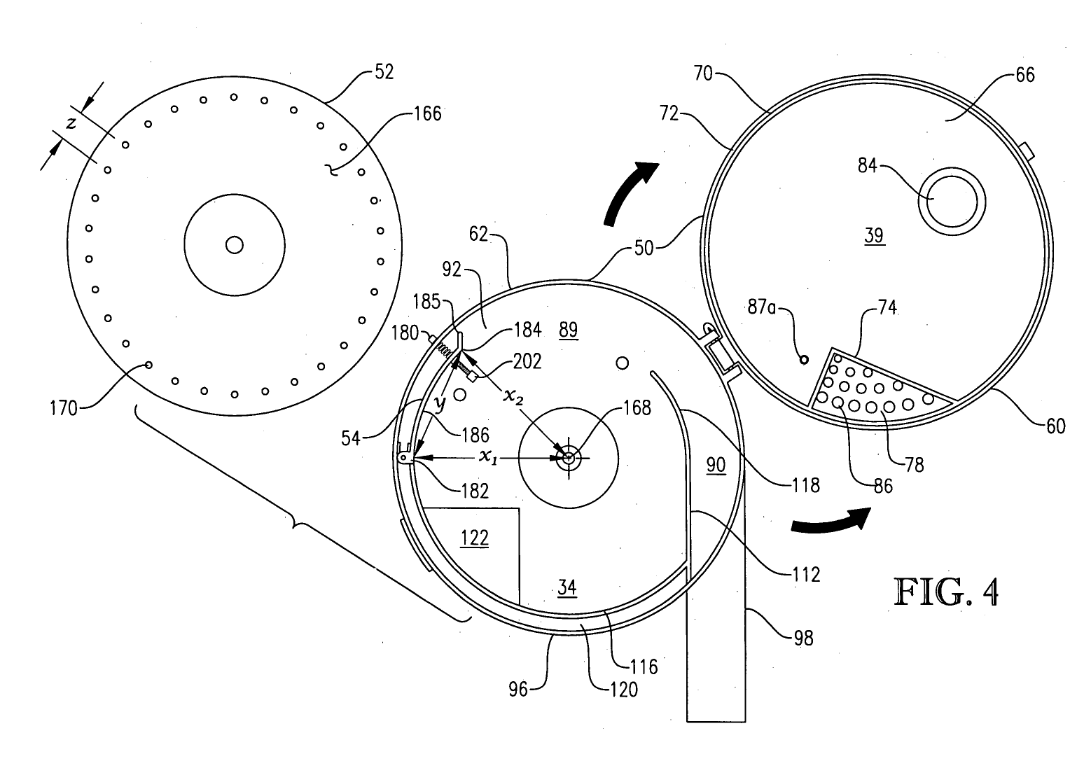

FIG. 3 illustrates the seed meter 10 in a closed condition, while FIG. 4 illustrates the seed meter 10 in an open condition. Referring to FIGS. 3-8, the seed meter 10 generally includes a housing 50, an improved seed disk 52, an improved seed eliminator 54, a closing latch subassembly 56, and a drive subassembly 58. When the housing 50 is in the closed condition, the housing 50 defines an internal chamber within which the seed disk 52 is received. The seed disk 52 is rotatable relative to the housing 50 on a disk axis of rotation 168. The seed disk 52 divides the internal chamber of housing 50 into a pressure-control portion (located on one side of the seed disk 52) and a seed transfer portion (located on the other side of the seed disk 52). A pressure-control side 166 of the seed disk 52 defines part of the pressure-control portion of the internal chamber, while a seed-transfer side 164 of the seed disk 52 defines part of the seed-transfer portion of the internal chamber. The seed-transfer portion of the internal chamber includes a seed attachment zone 89 and a seed disengagement zone 90, which are separated by a substantially rigid separator plate 112. The seed attachment zone 89 includes the seed bin 34. The pressure-control portion of the internal chamber includes a vacuum zone 39 and an ambient zone 78, which are separated by a substantially rigid, generally L-shaped separator wall 74. The vacuum zone 39 adjacent the pressure-control side 166 of the seed disk 52 corresponds to the seed attachment zone 89 adjacent the seed-transfer side 164 of the seed disk 52, while the ambient zone 78 adjacent the pressure-control side 166 of the seed disk 52 corresponds to the seed disengagement zone 90 adjacent the seed-transfer side 164 of the seed disk 52. In operation, when the seed disk 52 rotates through the seed bin 34 of the seed attachment zone 89, a vacuum attachment force generated in the vacuum zone 39 couples seed 30 to the seed attachment holes 170 of the seed disk 52. The attached seeds 30 are then carried by the rotating seed disk 52 to the seed disengagement zone 90 where the vacuum attachment force is reduced or eliminated by the ambient zone 78, thereby decoupling the seeds 30 from the seed disk 52. The decoupled seeds 30 can then fall through a guide tube 98 and the ejector tube 11 for placement in the soil.

As described in more detail below, the seed eliminator 54 is positioned alongside the seed-transfer side 164 of the seed disk 52 and is configured to contact at least some of the seeds 30 transported on the seed disk 52. The primary purpose of the seed eliminator 54 is to decouple one of two seeds 30 held by a single attachment hole 170 (i.e., the elimination of “doubles”). However, seed eliminator 54 can be shifted via contact with seeds 30 that are firmly coupled to seed disk 52 so as to prevent shearing of the seeds 30 and/or deflection of the seed disk 52. A significant feature of the illustrated seed meter 10 is the fact that no brushes or gaskets are maintained in contact with the rotating seed disk 52. Rather, the only non-rotating solid items that contact the rotating seed disk 52 during operation are the seeds 30 in the seed bin 34.

As shown in FIGS. 4-8, the housing 50 includes a pressure-control subhousing 60 and a seed-transfer subhousing 62. The pressure-control subhousing 60 includes an outer panel 66 and an endless side wall 70 of predetermined height. The side wall 70 extends along the outer panel 66 and is spaced inwardly from the outer circumference of the panel 66 to present an outer margin 72. A substantially rigid L-shaped separator wall 74 extends from the inner surface of panel 66 and cooperates with a portion of the side wall 70 to laterally enclose the ambient zone 78. This separator wall 74 cooperates with the side wall 70 and the seed disk 52 to separate the pressure-control portion of the internal chamber into the vacuum zone 39 and the ambient zone 78. Preferably, the separator wall 74 presents a substantially planar, substantially rigid terminal edge that is spaced from and extends alongside the seed disk 52. The spacing of the separator wall 74 from the seed disk 52 is described below as dimension D2 in FIG. 9.

The outer panel 66 defines a vacuum inlet 84 adjacent the vacuum zone 39 and a plurality of ambient openings 86 adjacent the ambient zone 78. The vacuum inlet 84 is sized and configured to communicate with the vacuum source 38 so that the pressure within the vacuum zone 39 is sufficiently reduced. More preferably, the inlet 84 cooperates with the vacuum source 38 to reduce the pressure to within a range of three to fourteen inches of water depending on the size of the seed. The plurality of ambient openings 86 are sized and configured to expose the ambient zone 78 to ambient air conditions outside of the meter 10. A testing aperture 86a is defined by the outer panel 66, and is located adjacent the vacuum zone 39. The aperture 87a presents an internally threaded hole. A short bolt 87b is threadably inserted in the aperture 87a during normal operation to maintain the vacuum zone 39. A conventional air-pressure measuring device can be utilized to test the vacuum in vacuum zone 39 by first removing the bolt 87b, and then coupling the device in aperture 87a. Panel 66 can also include openings for bolting the seed meter 10 to the supporting structure of the planter 8.

The preferred seed-transfer subhousing 62 generally presents a circular cross-section having an equal radius to the pressure-control subhousing 60. The seed-transfer subhousing 62 includes an outer seed panel 92 and a seed side wall 96 that extends orthogonally from the circumference of the outer seed panel 92 and presents a side wall thickness that is less than the width of margin 72 of the pressure-control subhousing 60, so that the subhousings 60,62 can be slidably interfitted as shown in FIG. 8. More preferably, the wall thickness is not less than ninety percent of the width of the margin 72, so that the overlapping side walls 70,96 forms a substantially air-tight seam. It is further appreciated that a snug fit reduces noise caused by rattling during operation. An O-ring seal (not shown), can be provided in the margin 72 to form an intermediate seal between sidewall 70 and outer panel 92, and a band of shock absorbent material (not shown) may also be included between the interfitted sidewalls 70,96.

Seed-transfer housing 62 and seed disk 52 cooperate to form the seed attachment zone 89 and the seed disengagement zone 90 adjacent the seed-transfer side 164 of the seed disk 52. The seed attachment zone 89 and the seed disengagement zone 90 (on one side of the seed disk 52) correspond positionally with the vacuum zone 39 and ambient zone 78 (on the opposite side of the seed disk 52). Thus, the vacuum attachment force from the vacuum zone 39 causes the seeds 30 to attach to the seed disk 52 in the seed attachment zone 89, while the ambient zone 78 releases the vacuum attachment force, thereby allowing for disengagement of the seeds 30 from the seed disk 52 in the seed disengagement zone 90.

As shown in FIGS. 3-7, guide tube 98 is attached to the side wall 96 of the seed-transfer subhousing 62 proximate an opening in side wall 96. The opening in side wall 96 allows seeds 30 to fall from the disengagement zone 90 into guide tube 98. The preferred guide tube 98 presents a rectangular lateral cross-section.

Also attached to and extending from the outer seed panel 92 are the substantially rigid separator plate 112 and a seed bin plate 116. The separator plate 112 is operable to separate the seed bin 34 from the disengagement zone 90. The seed bin plate 116 presents a circular arc configuration that is concentrically aligned with the side wall 96. Both the separator plate 112 and the seed bin plate 116 preferably present a substantially rigid, generally planar terminal edge that extends alongside the seed disk 52 and is marginally spaced from seed disk 52 by a distance (D3) described below with reference to FIG. 9. The preferred seed bin plate 116 is connected to the separator plate 112 and extends away from the guide tube 98 to the quadrant diametrically opposite the beginning connection point. For example, as illustrated in FIG. 4, the seed bin plate 116 connects to the separator plate 112 between four and five o'clock and extends in a clockwise direction to about nine o'clock. To enable the efficient use of the seed bin 34, the seed bin plate 116 is spaced inwardly from side wall 96, so that a region 120 is defined therebetween. It is within the ambit of the present invention to fill the region 120 to prevent the accumulation of particulate therein. Also shown in FIG. 4, a seed inlet 122 is defined by the seed-transfer subhousing 62. Seed from seed hopper 24 passes through the inlet 122 and into the seed bin 34 of the seed meter 10. The preferred inlet 122 is defined within a first quadrant of the seed subhousing 62, generally extending between 6 and 9 o'clock (FIG. 4).

As perhaps best shown in FIG. 3, the closing latch subassembly 56 is provided for retaining the subhousings 60,62 in an interfitted or closed position. The closing latch subassembly 56 preferably includes at least two co-axially aligned cotter pin receiving sleeves 130a,b separately attached to the outside of side wall 96 of the seed-transfer subhousing 62 and outer panel 66 of the pressure-control subhousing 60, and a hairpin cotter clip fastener 132 that is removably received by the coaxially aligned cotter pin sleeves 130. It is appreciated by those skilled in the art, however, that other removable fasteners may be utilized including a bolt and nut assembly, cotter pins, and C-clips. The closing latch assembly 56 also includes a latch 134 and a latch receiving bracket 136. The bracket 136 is fixedly attached to and overhangs the side wall 96 of the seed-transfer subhousing 62. The latch 134 is pivotally coupled to the vacuum inlet 84 and presents a pivotal arm 140 that overhangs the outer panel 66. The bracket 136 defines a slot 138 (FIG. 6) that is configured to retainably engage the arm 140. The closing latch subassembly 56 also includes an elbow connector 142 for attaching to the vacuum tube 40, and a sealing collar 144 for maintaining an air-tight seal between the vacuum source 38 and internal chamber defined within the housing 50.

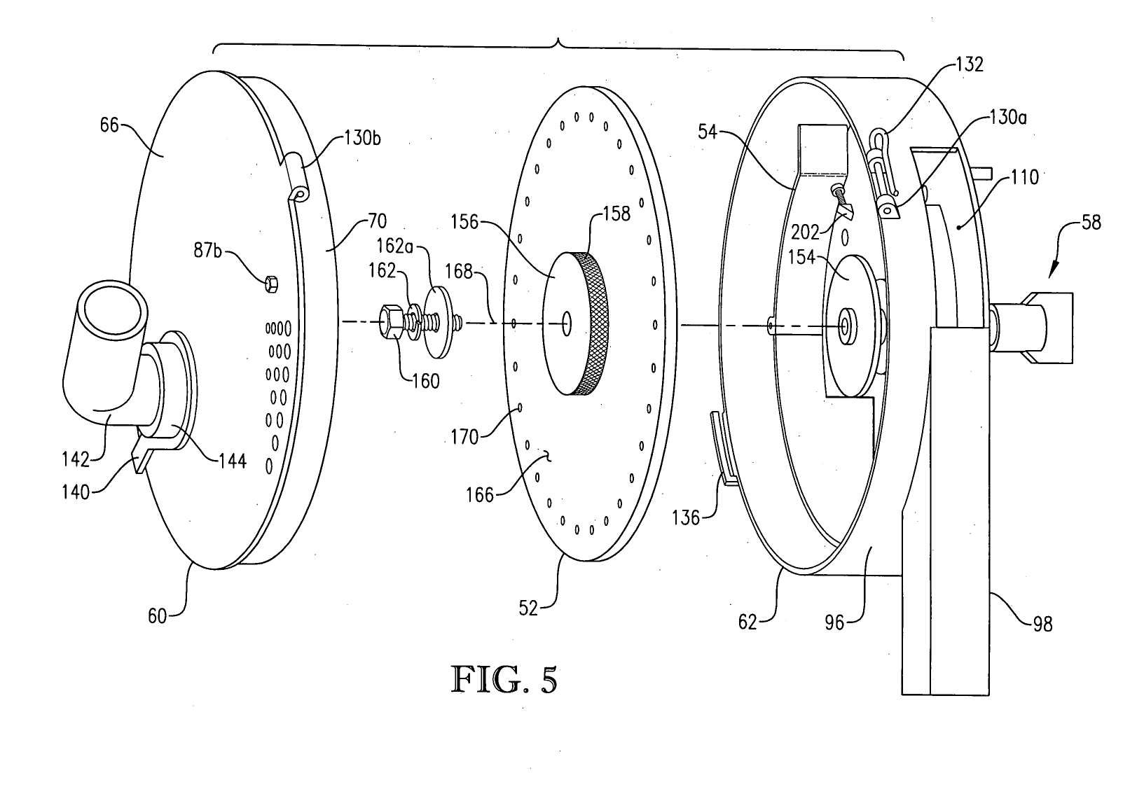

Turning to the drive subassembly 58 shown in FIGS. 5-8, the outer panel 92 of the seed-transfer subhousing 62 also defines a central opening (not shown) that is configured to receive a bearing assembly 146 and a drive shaft 148. The drive shaft 148 presents a keyed end 150 for connection to a drive mechanism 20 (FIG. 1), and an opposite end 152 for connecting to the seed disk 52. The opposite end 152 presents a tapped hole (not shown) that is configured to co-axially align with a tapped hole defined by the seed disk 52. A back washer 154 is sandwiched between the shaft 148 and disk 52, and a front end cap 156 is provided on the opposite side of the disk 52 to further secure the connection of the disk 52 to the drive shaft 148. More preferably, the front end cap 156 is integrally formed with the disk 52 and presents a serrated, knurled or otherwise roughened side surface 158 to facilitate the removal of the disk 52 even in moist conditions (see FIG. 5). As such, the roughened surface 158 is sufficiently wide enough to be easily grasped by a user (not shown), and is more preferably not less than one quarter of an inch (¼″) in width. To fasten the components together, a threaded bolt 160 is removably received by the front end cap 156, disk 52, back washer 154, and shaft 148. Finally, a lock washer 162 and an intermediate washer 162a are also provided between the front end cap 156 and bolt head to facilitate the removal of the bolt 160 (see FIG. 8).

When the seed meter 10 is in the closed operating condition, the components of the drive subassembly 58 are dimensioned and configured to space the seed disk 52 from all of the other components of the meter 10, not including the seed 30 in seed bin 34. As best shown in FIG. 9, the disk 52 is spaced a distance D1 from the terminal edges of the separator and seed bin plates 112,116 of the seed-transfer subhousing 62, a distance D2 from the terminal edge of the L-shaped separator wall 74 and side wall 70 of the pressure subhousing 60, and a distance D3 from side wall 96 of the pressure control subhousing 60. Preferably, D1, D2, and D3 are less than about one eighth of an inch (⅛″), more preferably less than about one sixteenth of an inch (1/16″), and most preferably less than one sixty-fourth of an inch (1/64″). These close tolerances between seed disk 52 and other non-rotating structures of the seed meter 10 allow for the elimination of various brushes, gaskets, and disk supports that are used in prior art devices. However, as discussed below, seed disk 52 should be able to resist bending to a degree such that contact between seed disk 52 and the minimally-spaced fixed components of the seed meter 10 is avoided.

As best shown in FIGS. 4-6, the improved seed disk 52 is formed from a substantially flat panel having generally opposite and parallel seed-transfer and pressure-control faces 164,166. As previously mentioned, the disk 52 is fixedly connected to the drive subassembly 58, which rotates the disk 52 about the disk axis of rotation 168. The disk 52 defines a plurality of symmetrically configured seed attachment apertures or holes 170 that completely pass through the disk 52. In the illustrated embodiment, the holes 170 are axially oriented, and equally spaced from the axis 168, so as to present a circular ring having a radius of about four and one-quarter inches (4¼″), when measured from the center of each of the holes 170 to the axis 168.

Referring to FIGS. 6-9, each of the axially-extruding seed attachment holes 170 is configured to carry a single seed and presents a minimum diameter that is less than the minimum seed diameter. Preferably, the minimum diameter of each hole is within the range of one eighth to one fourth of an inch (⅛″-¼″), more preferably within the range of five thirty-seconds to seven thirty-seconds of an inch (5/32″-7/32″), still more preferably within the range of eleven sixty-fourths to thirteen sixty-fourths of an inch (11/64″-13/64″), and most preferably about three sixteenths of an inch (3/16″). At least a portion of the attachment hole 170 defining the minimum diameter is axially spaced from the vacuum face 166 not less than one eighth of an inch (⅛″), preferably not less than three sixteenths of an inch (3/16″), and most preferably not less than one fourth of an inch (¼″), so that no portion of even relatively elongated seeds 30 are able to pass completely through the hole 170 (FIG. 9). As illustrated in FIGS. 8 and 9, each of the preferred holes 170 presents a non-tapered cylindrical configuration, so that the minimum diameter is presented along the entire axial length of the hole, including at the seed surface 164. Thus, it is preferred for hole 170 not to be rounded at the seed surface 164. It is believed that the funnel-like shape of a seed hole that is rounded at the seed surface can cause an increase in the planting of double seeds, especially when the seeds are of highly variable sizes and shapes.

The improved seed disk 52 provides an enhanced resistance to bending that minimizes the deflection of the disk 52 during operation. The prevention of bending and warping of the seed disk 52 reduces internal friction caused by contact between the disk 52 and the housing 50 and allows for close tolerances to be maintained between the seed disk 52 and certain portions of the housing 50. In turn, these close tolerances allow for the elimination of conventional gaskets and/or brushes. As shown in FIG. 12, the bending resistive strength of the seed disk 52 can be determined by fixing the disk 52 at its central axis, applying a normal force (F) at a location spaced a radial distance (r) from the central disk axis, and measuring the deflection (Δd) of the disk at the location where the force (F) is applied. Inventive seed disk 52 was tested, as described above, to determine the magnitude of force (F) required to cause a one-eighth inch (⅛″) deflection (Δd) at a five inch (5″) radial distance (r) from the axis of rotation of disk 52. Preferably, a normal force of at least five pounds is required to cause a one-eighth inch (⅛″) deflection at five inches (5″) from the disk axis, more preferably a normal force of at least twenty-five pounds is required to cause such a deflection, still more preferably a normal force of at least fifty pounds is required to cause such a deflection, and most preferably a normal force of at least one hundred pounds is required to cause such a deflection. The bending resistive strength of the disk 52 is partially dependent upon the modulus of elasticity (i.e., Young's Modulus) of the material that forms the disk 52. As such, the preferred material utilized in the fabrication of the disk 52 presents a modulus of elasticity not less than 5×10⁶ psi, and most preferably not less than 10×10⁶ psi. Preferably, the disk 52 can be formed by material selected from the group consisting of graphite, aluminum alloys, high grade plastics, soft steel, and copper alloys, with aluminum alloy being preferred amongst the group. Finally, the preferred disk 52 is also formed of a material having a hardness rating (i.e. relative resistance to indentation) as measured by the Brinell test, within the range of 20 to 180 bhn, and more preferably within the range of 50 to 140 bhn. One such suitable aluminum alloy is A1 2014-T6, which has a Young's Modulus of 10.9×10⁶ psi and a Brinell hardness of 135. This relatively high hardness rating inhibits wear of the disk 52. Of course, the thickness of the disk 52 affects its ability to resist bending and also its ability to prevent seeds from extending entirely through seed holes 170. Thus, it is preferred for the disk 52 to have a thickness proximate the seed holes 170 that is within the range of one eighth to one half of an inch (⅛″-½″), more preferably within the range of three sixteenths to five sixteenths of an inch (3/16″-5/16″), and still more preferably within the range of seven thirty-seconds to nine thirty-seconds of an inch (7/32″-9/32″), and most preferably about one quarter of an inch (¼″).

As best shown in FIGS. 6,7, and 10, the seed-transfer surface 164 of seed disk 52 defines a plurality of symmetrically configured, substantially identical grooves 172. Preferably, the grooves 172 are configured in a circular ring around the central disk axis 168, and each groove corresponds to one of the seed holes 170. Each of the grooves 172 is individually configured to agitate, but not substantially lift, the plurality of seeds 30 in the seed bin 34 as the disk 52 rotates therethrough. To this effect, each of the grooves 172 is formed by a generally rectangular cut-out section having a radially oriented longitudinal axis. Each groove defines leading and trailing edges based on the direction of rotation, and a chamfered or filleted groove region 174 adjacent the trailing edge (FIG. 10). However, it is well within the ambit of the present invention for the grooves to be formed in other cut-out shapes. The chamfered or filleted region 174 presents a slope or taper that prevents seeds from being lifted by the groove but does not prevent the agitation of the seeds 30. More specifically, the sloped region 174 enables the seeds to slide out of the groove 72 as it rotates out of the seed bin 34. As shown in FIG. 10, each of the grooves 172 presents a depth that is not greater than one half the thickness of the disk 52 proximate the groove 72. More preferably, each groove 72 presents a depth of about one third the thickness of the disk 52 adjacent the groove 72.

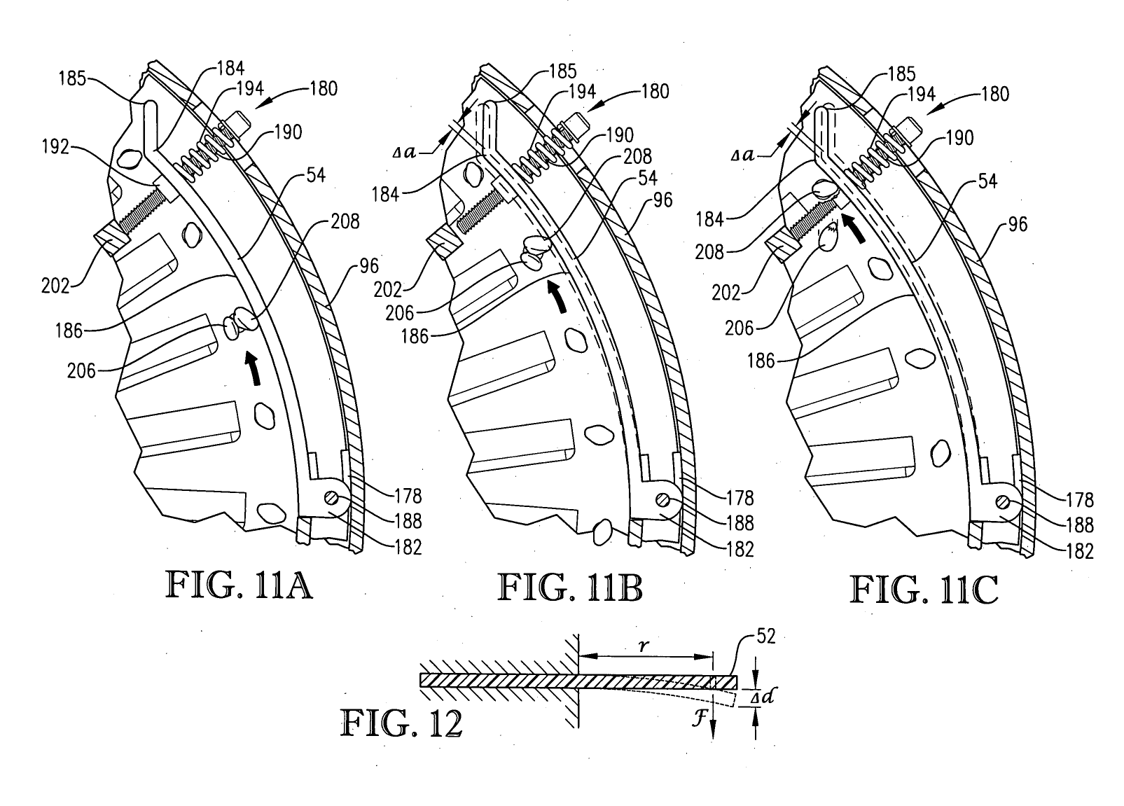

Turning to FIGS. 4, 5, and 11A-C, the improved eliminator 54 is configured to engage and dislodge excess seeds that attach to an individual seed hole 170 without damaging the excess seeds. The eliminator 54 dislodges the excess seeds by gradually encroaching the travel path of the excess seeds. Upon dislodgment, the excess seeds are able to return to the seed bin 34 for proper use. The seed eliminator 54 is shiftable between a normal or stopped position (FIGS. 11A and 11C) and a deflected or shifted position (FIG. 11B). A biasing mechanism 178 (e.g., a torsion spring) is operable to bias the seed eliminator 54 towards the normal position. An adjustment mechanism 180 is provided for adjusting the encroachment of the eliminator 54 when the eliminator 54 is in the normal position.

The preferred seed eliminator 54 is formed of a thin rectangular plate having a pivoting end 182, a free end 184, and a substantially smooth, non-serrated leading edge 186 extending from the pivoting end 182 to the free end 184. The pivoting end 182 defines a sleeve that is coupled to the seed-transfer subhousing 62 via an eliminator pin 188 (FIG. 11A so that the eliminator 54 is translationally fixed relative to the housing 50. As shown in FIG. 4, the leading edge 186 at the pivot end 182 is spaced a radial distance x₁ from the axis of rotation 168, while the leading edge 186 at the free end 184 is spaced a radial distance x₂ from the axis of rotation 168. The leading edge 186 of seed eliminator 54 presents a curvilinear profile that encroaches closer to the axis of rotation 168 as the leading edge 186 extends from the pivoting end 182 to the free end 184. Preferably, when the seed eliminator 54 is in the normal (i.e., undeflected) position, x₂ is at least one sixteenth of an inch (1/16″) less than x₁, and most preferably at least one eighth of an inch (⅛″) less than x₁. As shown in FIG. 4, leading edge 186 extends a distance (y) from pivoting end 182 to free end 184. To enable a more gradual encroachment, the length y is preferably not less than the center-to-center spacing (z) between adjacent seed holes 170 of the seed disk 52 (see FIG. 4). More preferably, the ratio of y to z is greater than 2:1, still more preferably greater than 3:1, and most preferably in the range of 3:1 to 10:1. Preferably, y is greater than one inch (1″), more preferably greater than two inches (2″), and most preferably in the range of three to six inches (3″-6″). Preferably, z is in the range of one-quarter to two inches (¼″-2″), and most preferably three-quarters to one and one-quarter inches (¾″-1¼″).

Also shown in FIGS. 4 and 11A-C, an adjustment mechanism 180 is provided to adjust the radial distance x₂ between the axis of rotation 168 and the free end 184 of the seed eliminator 54 when the seed eliminator 54 is in the normal position. The preferred adjustment mechanism 180 includes a threaded bolt 190 that is threadably received within an internally threaded hole defined by the seed eliminator 54 and a stop 202 that is rigidly attached to seed-transfer subhousing 62. The bolt is preferably received at or near the free end 184 of the seed eliminator 54, so as to enable finer adjustments of the eliminator 54. A coaxially aligned lock nut 192 is provided adjacent the leading edge 186 to hold the bolt 190 in place. Finally, a compression spring 194 is provided between the bolt 190 and seed eliminator 54 to inhibit free rotation of the bolt 190 relative to seed eliminator 54.

A seed guard 185 can be provided to prevent seeds from entering and accumulating in the space between seed eliminator 54 and side wall 96 of seed-transfer subhousing 62. Seed guard 185 extends generally between the free end 184 of seed eliminator 154 and side wall 96. The illustrated embodiment shows seed guard 185 being fixed to seed eliminator 54 and extending towards side wall 96. However, it is entirely within the ambit of the present invention for seed guard 185 to be fixed to side wall 96 and extend towards (but not contact) seed eliminator 54.

The seed eliminator 54 is preferably located in an upper quadrant of the internal chamber defined between nine and twelve o'clock as illustrated in FIG. 4. It is appreciated that this configuration reduces creeping of the plurality of seed 30 into the eliminator 54, and therefore, promotes the full utilization of the seed bin 34, as well as the proper function of the eliminator 54.

Although, the configuration of a preferred embodiment of the improved eliminator 54 is herein described and illustrated, it is certainly within the ambit of the present invention to present alternative configurations for the seed eliminator 54, biasing mechanism 178 and adjustment mechanism 180. For example, the seed eliminator 54 need not present a thin rectangular shape, so long as a gradually curvilinear leading edge of aforementioned length is provided.

The operation of the improved seed meter 10 is best shown in FIGS. 7, and 11A-C. The plurality of seeds 30 gravitationally flows from the seed hopper 24 and into the seed bin 34 defined by the housing 50. The vacuum source 38 provides negative pressure within the vacuum zone 39 that draws air from the exterior of the housing 50 primarily through air inlet 110 and through seed holes 170. The velocity gradient of the flowing air lifts and attaches at least one seed to each hole, where the seed is retained by the force of the vacuum. If an excess seed is also attached to a seed hole 170, as shown in FIG. 11A, the leading edge 186 gradually engages the radially outermost seed 208 until the excess seed (i.e. either the radially outermost seed 208 or innermost seed 206) is dislodged. If a seed being contacted by the seed eliminator 54 becomes temporarily immovable or “stuck,” the seed eliminator 54 pivots to a deflected position, as shown in FIG. 11B, so as not to shear the seed or bend the disk 52. In the deflected position, the free end 184 swings about the pivotal end 182 a deflected distance (Δa). Preferably, Δa is greater than one sixteenth of an inch (1/16″) and most preferably greater than one eighth of an inch (⅛″). The biasing mechanism 178 causes seed eliminator 54 to increasingly bear against the radially outermost seed 208 to encourage the dislodgement of the excess seed as the seed eliminator 54 shifts to the deflected position (FIG. 11B). Once the excess seed is removed, the biasing mechanism 178 forces the seed eliminator 54 back to the normal position (FIG. 11C), where the cycle is ready to be repeated. Where the seeds present larger average diameters, the seed eliminator 54 can be outwardly adjusted by inserting the bolt 190 further into the seed eliminator 54 and locking nut 192, so that x₂ is increased when the seed eliminator 54 is in the normal (i.e., undeflected) position. Conversely, where smaller seeds are encountered, the bolt 190 may be withdrawn so that the free end 184 is brought closer to the axis of rotation 168, thereby reducing x₂ in the normal position.

As the disk 52 rotates a properly attached seed is carried from the bin 34 to the disengagement zone 90, where the vacuum attachment force is terminated. In the disengagement zone 90, the seed is dislodged and drops through the guide tube 98. More preferably, the rates of transport and rotation of the disk 52, as well as the configuration of the disengagement zone 90, enable the seed to drop in a generally linear path through the tube 98.

The preferred forms of the invention described above are to be used as illustration only, and should not be utilized in a limiting sense in interpreting the scope of the present invention. Obvious modifications to the exemplary embodiments and modes of operation, as set forth herein, could be readily made by those skilled in the art without departing from the spirit of the present invention.

The inventor hereby states his intent to rely on the Doctrine of Equivalents to determine and assess the reasonably fair scope of the present invention as pertains to any apparatus not materially departing from but outside the literal scope of the invention as set forth in the following claims.

1. A seed meter comprising:
a housing at least partly defining a seed bin and a disengagement zone;
a seed disk operable to carry seeds from the seed bin to the disengagement zone when rotated relative to the housing on a disk axis of rotation; and
a seed eliminator at least partly disposed alongside the seed disk and operable to contact at least one of the seeds carried by the seed disk,
said seed eliminator being shiftable from a normal position to a deflected position via contact with said at least one of the seeds.

2. The meter as claimed in claim 1,
at least a portion of said eliminator shifting at least about 1/16″ away from the disk axis when the seed eliminator is shifted from the normal position to the deflected position.

3. The meter as claimed in claim 1,
said seed eliminator being translationally fixed relative to the housing,
said seed eliminator pivoting away from the disk axis when shifted from the normal position to the deflected position.

4. The meter as claimed in claim 1,
said seed eliminator including spaced apart first and second ends,
said seed eliminator presenting a substantially smooth leading edge extending from the first end to the second end,
said leading edge being closer to the disk axis of rotation at the second end than at the first end when the seed eliminator is in the normal position.

5. The meter as claimed in claim 4,
said leading edge being at least about ⅛″ closer to the disk axis of rotation at the second end than at the first end when the seed eliminator is in the normal position.

6. The meter as claimed in claim 4,
said seed disk defining a plurality of spaced apart seed holes for holding the seeds against the seed disk via vacuum force,
said leading edge extending further than the minimum distance between adjacent ones of said seed holes.

7. The meter as claimed in claim 6,
said leading edge extending a distance that is at least twice the minimum distance between adjacent ones of said seed holes.

8. The meter as claimed in claim 4, said leading edge extending at least about 2″.

9. The meter as claimed in claim 4, said leading edge having substantially no serrations.

10. The meter as claimed in claim 4; and
an adjustment mechanism coupled to the housing and the seed eliminator,
said adjustment mechanism being configured to vary the distance between the leading edge and the disk axis of rotation when the seed eliminator is in the normal position.

11. The meter as claimed in claim 10,
said adjustment mechanism including an adjuster element adjustably coupled to the seed eliminator and a stop fixedly attached to the housing,
said adjuster element engaging the stop when the seed eliminator is in the normal position,
said adjuster element being spaced from the stop when the seed eliminator is in the deflected position.

12. The meter as claimed in claim 11,
said adjuster element and said seed eliminator being threadably intercoupled so that rotation of the adjuster element causes at least a portion of the adjuster element to shift towards or away from the leading edge.

13. The meter as claimed in claim 12,
said adjustment mechanism including a compression spring contacting the adjuster element and the seed eliminator,
said compression spring being configured to restrain relative rotation of the adjuster element and the seed eliminator.

14. The meter as claimed in claim 1; and
a biasing mechanism configured to bias the seed eliminator towards the normal position.

15. The meter as claimed in claim 14,
said biasing mechanism comprising a torsion spring.

16. The meter as claimed in claim 1,
said seed disk presenting a seed surface and a vacuum surface facing generally opposite the seed surface,
said seed disk defining a plurality of spaced-apart seed holes for holding the seeds against the seed side of the disk via vacuum force,
each of said plurality of seed holes presenting a minimum hole diameter,
said minimum hole diameter being spaced from the vacuum surface by a distance of at least about 3/16″.

17. The meter as claimed in claim 1,
said seed disk having a resistance to bending such that a normal force greater than about 5 pounds is required to cause a deflection of ⅛″ when the disk is fixed at the disk axis and the force and deflection are applied and measured at a location 5″ from the disk axis.

18. The meter as claimed in claim 1,
said seed disk defining a plurality of grooves,
each of said plurality of grooves being configured to agitate the seeds as the groove rotates through the seed bin,
each of said plurality of grooves presenting leading and trailing edges as the disk rotates,
said trailing edge presenting a tapered surface.

19. The meter as claimed in claim 1,
said seed disk and said housing being configured so that substantially the only items contacting the seed disk but not rotating with the seed disk are the seeds in the seed bin.

20. A seed meter comprising:
a housing at least partly defining an internal chamber; and
a seed disk at least partly disposed in the housing and rotatable relative thereto,
said seed disk dividing the internal chamber into a seed-transfer portion and a pressure-controlled portion,
said seed disk presenting a seed side adjacent the seed transfer-portion and a vacuum side adjacent the pressure-controlled portion,
said seed disk defining a plurality of seed attachment holes extending axially through the disk from the seed side to the vacuum side,
each of said seed holes having a minimum diameter,
said minimum diameter being axially spaced from the vacuum side by at least about ⅛″.

21. The meter as claimed in claim 20,
said minimum diameter being axially spaced from the vacuum side by at least about 3/16″.

22. The meter as claimed in claim 20,
said minimum diameter being axially spaced from the vacuum side by at least about ¼″.

23. The meter as claimed in claim 22,
said minimum diameter being in the range of from about ⅛″ to about ¼″.

24. The meter as claimed in claim 20,
said seed side of the seed disk defining a plurality of grooves.

25. The meter as claimed in claim 24,
each of said grooves presenting leading and trailing edges,
said trailing edge presenting a tapered surface.

26. A seed meter comprising:
a housing at least partly defining a seed bin and a disengagement zone; and
a seed disk disposed within and rotatable relative to the housing on a disk axis of rotation,
said seed disk defining a plurality of seed attachment holes configured to carry seeds from the seed bin to the disengagement zone when the disk is rotated,
said seed disk having a resistance to bending such that a normal force greater than about 5 pounds is required to cause a deflection of ⅛″ when the disk is fixed at the disk axis and the force and deflection are applied and measured at a location 5″ from the disk axis.

27. The meter as claimed in claim 26,
said seed disk having a resistance to bending such that a normal force greater than about 25 pounds is required to cause a deflection of ⅛″ when the disk is fixed at the disk axis and the force and deflection are applied and measured at a location 5″ inches from the disk axis.

28. The meter as claimed in claim 26,
said seed disk being formed of material having a modulus of elasticity of at least about 5×10⁶ psi,
said seed disk being formed of material having a Brinell hardness rating within the range of about 20 to about 180 bhn.

29. The meter as claimed in claim 26,
said seed disk being formed of a material comprising aluminum.

30. The meter as claimed in claim 26,
said seed disk having a thickness not less than about 3/16″ proximate the seed attachment holes.

31. The meter as claimed in claim 26,
said seed disk defining a plurality of grooves,
each of said plurality of grooves being configured to agitate the seeds as the groove rotates through the seed bin,
each of said plurality of grooves presenting leading and trailing edges as the disk rotates,
said trailing edge presenting a sloped surface.

32. The meter as claimed in claim 26,
said seed disk and said housing being configured so that substantially the only non-rotating items contacting the seed disk are the seeds in the seed bin.

33. A seed meter comprising:
a housing at least partly defining an internal chamber; and
a seed disk at least partly disposed in the chamber and dividing the internal chamber into a seed-transfer portion and a pressure-controlled portion,
said housing including a substantially rigid separator wall dividing the pressure-controlled portion into a vacuum zone and an ambient zone,
said separator wall being spaced from the seed disk,
said separator wall presenting a substantially rigid terminal edge extending alongside the seed disk,
said terminal edge being spaced from the seed disk by a maximum distance of not more than about 1/16″.

34. The meter as claimed in claim 33,
said terminal edge being spaced from the seed disk by a maximum distance of not more than 1/32″.

35. The meter as claimed in claim 33,
said terminal edge being substantially planar.

36. A rotatable seed disk adapted for use in a vacuum seed meter, said disk comprising:
a substantially flat and substantially circular panel,
said panel presenting first and second generally parallel and opposite faces,
said panel defining a central axis of rotation and a plurality of seed attachment holes equally spaced from the axis of rotation and from one another,
each of said seed attachment holes presenting a minimum diameter that is spaced from one of said first and second faces by at least about 3/16″.

37. The seed disk as claimed in claim 36,
said panel having a thickness not less than about ¼″ proximate each of the seed attachment holes.

38. The seed disk as claimed in claim 36,
said panel having a resistance to bending such that a normal force greater than about 25 pounds is required to cause a deflection of ⅛″ when the panel is fixed at the axis of rotation and the force and deflection are applied and measured at a location 5 inches from the axis of rotation.

39. The seed disk as claimed in claim 38,
said panel being formed of material having a modulus of elasticity not less than about 5×10⁶ psi,
said panel being formed of material having a Brinell hardness rating within the range of about 20 to about 180 bhn.

40. The seed disk as claimed in claim 38,
said panel being formed of a material comprising aluminum.

41. The seed disk as claimed in claim 36,
said panel defining a plurality of grooves,
each of said plurality of grooves presenting leading and trailing edges,
said trailing edge presenting a tapered surface.

42. The seed disk as claimed in claim 41,
said grooves being equally spaced from one another and from the axis of rotation.

43. A method of metering seeds, said method comprising the steps of:
(a) introducing the seeds into a seed meter comprising a housing and a seed disk disposed in the housing, said housing and said seed disk cooperatively defining a seed bin for holding the seeds;
(b) coupling a plurality of the seeds to the seed disk;
(c) rotating the seed disk relative to the housing to thereby transport the seeds coupled to the disk from the seed bin to a disengagement zone; and
(d) decoupling the seeds from the seed disk in the disk engagement zone,
said rotating of step (c) being performed without contacting the seed disk with any non-rotating solid items other than the seeds in the seed bin.

44. The method as claimed in claim 43,
step (b) including using a vacuum attachment force to couple said plurality of the seeds to the seed disk,
step (d) including reducing the magnitude of the vacuum attachment force.

45. The method as claimed in claim 43; and
(e) simultaneously with step (c), contacting at least one of the seeds coupled to the seed disk with a seed eliminator.

46. The method as claimed in claim 45,
step (e) including causing the seed eliminator to shift relative to the housing via contact with said at least one of the seeds.

47. The method as claimed in claim 45,
step (e) including causing one of the seeds to become decoupled from the seed disk via contact with the seed eliminator.

48. The method as claimed in claim 45,
step (e) including contacting said at least one of the seeds with a substantially smooth, non-serrated leading edge of the seed eliminator.

49. The method as claimed in claim 43,
step (c) including using grooves formed in the seed disk to agitate the seeds in the seed bin.
